(19) United States
(12) Patent Application Publication
(10) Pub. No.: US 2026/0077287 A1
(43) Pub. Date: Mar. 19, 2026

(54) FILTER SYSTEM HAVING AT LEAST TWO FILTER ELEMENTS

(71) Applicant: MANN+HUMMEL GmbH, Ludwigsburg (DE)

(72) Inventors: Daniel SCHMID, Sachsenheim (DE); Thilo MÜLLER, Rutesheim (DE)

(21) Appl. No.: 19/396,508

(22) Filed: Nov. 21, 2025

Related U.S. Application Data
(63) Continuation of application No. PCT/EP2024/063491, filed on May 16, 2024.

(30) Foreign Application Priority Data
Jun. 6, 2023 (DE) 10 2023 114 799.4

(51) Int. Cl. B01D 46/00; B01D 46/52; B01D 46/62

(52) U.S. Cl. CPC B01D 46/0005; B01D 46/0036; B01D 46/521; B01D 46/62; B01D 2201/34

(57) ABSTRACT

A filter system has a filter housing with a fluid inlet and a fluid outlet. At least two exchangeable filter elements are arranged between the fluid inlet and the fluid outlet each having a filter body with a filter medium to be flowed through by a fluid in a flow direction. The filter elements each have an opposing end face with a seal surrounding an outer edge of the filter body at the end face. An abutment element is arranged between the seals when mounted in the filter housing. The abutment element has sides facing away from each other with a seal surface for contacting the seals. A filter element has a filter body with a filter medium and an end face with a seal surrounding an outer edge of the filter body at the end face for contacting a seal surface of an abutment element.

### CROSS-REFERENCE TO RELATED APPLICATIONS

This application is a continuation application of international application No. PCT/EP2024/063491 having an international filing date of May 16, 2024, and designating the United States, the international application claiming a priority date of June 6, 2023, based on prior filed German patent application No. 102023114 799.4, the entire contents of the aforesaid applications being incorporated herein by reference.

### BACKGROUND

The invention concerns a filter system with at least two exchangeable filter elements for filtering a fluid, for example for filtering air. The invention further concerns a filter element for filtering a fluid, for example air, for such a filter system. Furthermore, an advantageous use is disclosed.

Fuel cell systems often require a particle filter and an adsorption filter in order to filter particles as well as harmful gases out of the intake air. In this context, the filter bodies often have different service lives which makes a separation of both filter bodies or filter elements expedient so that the filter elements may be exchanged separately. In this way, servicing costs may be saved. The filter elements are configured frequently as flat filters, for example, but other filter element shapes are also available.

### SUMMARY

It is an object of the invention to provide a service-friendly and inexpensive filter system with at least two exchangeable filter elements for filtering a fluid, for example for filtering air.

A further object is providing a filter element for such a service-friendly and inexpensive filter system.

The aforementioned object is solved according to an aspect of the invention by a filter system including a filter housing with a fluid inlet and a fluid outlet and including at least two exchangeable filter elements for filtering a fluid, for example for filtering air, which are arranged between the fluid inlet and the fluid outlet, wherein the filter elements each include a filter body with a filter medium arranged, when in use as intended, to be flowed through by the fluid in a flow direction for flow passage, wherein, at end faces facing each other, the filter elements include seals surrounding outer edges, respectively, wherein, when the filter elements are mounted as intended in the filter housing, a circumferential abutment element is arranged between the seals and includes, at sides facing away from each other, seal surfaces for seal-tight contact of the seals.

The further object is solved by a filter element for filtering a fluid, for example air, for a filter system including a filter body with a filter medium arranged, when in use as intended, to be flowed through by the fluid in a flow direction for flow passage, wherein the filter body at an end face includes a seal surrounding an outer edge, which, when mounted as intended in a filter housing of the filter system, contacts seal-tightly a seal surface of a circumferential abutment element.

Embodiments and advantages of the invention result from the following description and the accompanying drawings.

According to one aspect of the invention, a filter system is proposed including a filter housing with a fluid inlet and a fluid outlet and including at least two exchangeable filter elements for filtering a fluid, for example for filtering air, which are arranged between the fluid inlet and the fluid outlet. The filter elements each include a filter body with a filter medium arranged, when in use as intended, to be flowed through by the fluid in a flow direction for flow passage. In this context, the filter elements, at end faces facing each other, include seals surrounding outer edges, respectively, wherein, when mounting the filter elements as intended in the filter housing, a circumferential abutment element is arranged between the seals which includes, at sides facing away from each other, seal surfaces for seal-tightly contacting the seals.

In the proposed filter system, the two filter elements may be configured, for example, as flat filter elements with foamed-on seal but other filter element shapes are also possible. Between the two seals of the filter elements, an abutment element is arranged in order to be able to realize the seal interface appropriately. The abutment element, for example, may be configured of plastic material, like the filter housing as well. The abutment element includes seal surfaces against which the seals rest seal-tightly. For example, a seal chamber may be formed in the abutment element, respectively, so that the seals stay in position and cannot move laterally.

The abutment element may be designed purely as a frame or may include a grid for stabilization, which is arranged inside of the frame and, in this way, stabilizes additionally the frame sides. In the installed state, the grid is positioned between the two filter elements and may thus serve also for supporting the end face of one or both filter elements.

At the respective far side of the seal surface, the seals are compressed by the filter housing or a housing part of the filter housing. In this way, a high seal-tightness between the filter elements and the abutment element is ensured.

One filter element may be configured as a particle filter element and the other filter element as an adsorption filter element. Due to the separate construction of the two filter elements, servicing of the particle filter element and of the adsorption filter element of a fuel cell system may be carried out separate from each other. Servicing costs may thus be beneficially reduced, for example in case of different service lives.

In this context, the seal profiles of the two seals may be designed identically or differently. When both seals are of the same configuration, the same tool for producing the two filter elements may be used, which is cost-efficient. In interaction with corresponding geometries at the housing, different seal profiles enable a defined installation so that a mixup of the filter elements may be prevented; this is advantageous when one filter element is embodied as a particle filter element and the other filter element as an adsorption filter element.

The abutment element may be arranged at one of the housing parts of the filter housing. As an alternative, it is also possible and indeed advantageous when the abutment element is configured as a loose insertion part of the filter housing.

According to an embodiment of the filter system, the abutment element may include at least one groove for at least partially receiving the seals. For example, due to the groove, a seal chamber may be formed in the abutment element, respectively, so that the seals stay in position and cannot laterally move when mounted in the filter housing.

According to an embodiment of the filter system, the respective seal at the filter body may be present in a radial direction, i.e., the seal surface of the seal is oriented radially inwardly or for example radially outwardly. As an alternative or in addition, the respective seal may be present at the filter body in an axial direction, i.e., the seal surface of the seal is oriented in axial direction upwardly or downwardly. For example, in this context at least one of the seals may be foamed onto the respective filter body. When the seal is present at the filter body in radial direction, the effective surface area for flow through the filter body is impaired as little as possible by the seal. When the seal is present at the filter body in axial direction, a defined distance between the two filter bodies may be adjusted. Also, a certain flexibility when mounting the filter element in the filter housing is provided so that manufacturing and mounting tolerances may be compensated. The respective seal may be arranged, at least mostly, radially outside of the end face of the filter element forming the inflow side or outflow side so that as little as possible of the filter surface area is covered by the seal and the force for compression is applied directly on the seal and acts less on the filter medium. The seals in this context may be foamed directly onto the filter body. In this context, polyurethane (PUR) may be used as a material, for example.

According to an embodiment of the filter system, the seals, when the filter housing is closed as intended, may be compressed against the respective seal surface of the abutment element in an axial direction. In this way, the seals may be axially compressed by means of the filter housing or by means of housing parts such as bottom part and top part in order to achieve a sealing action in this way.

According to an embodiment of the filter system, the respective seal may include a circumferential receptacle positioned opposite the seal surface and engaged by a housing part. In this way, the filter element may be expediently positioned in relation to the filter housing or a housing part such that the filter element is aligned for installation in the filter housing. Also, the two filter elements may be positioned reliably in relation to each other so that the seals of the two filter elements engage the respective seal surface. Due to the housing part engaging the receptacle of the seal, the seals may be compressed in axial direction when the filter housing is closed as intended so that the sealing action of the two filter elements in relation to the respective seal surface of the abutment element is ensured.

According to an embodiment of the filter system, the seals may be compressed in a radial direction against a radially outwardly positioned wall of the abutment element when the filter housing is closed as intended.

According to an embodiment of the filter system, the filter element which is flowed through first in the flow direction may be configured as a particle filter. As an alternative or in addition, the filter element following in the flow direction may be configured as an adsorption filter, for example as an active carbon filter and/or as an ion exchanger. For example, in fuel cell systems particles as well as harmful gases may be filtered out of the intake air in this way.

According to an embodiment of the filter system, the filter housing may surround the abutment element at a radially outer side. For example, in this context the filter housing may include at least one groove in which at least one wall of the abutment element engages. In this way, the seals may be protected from mechanical damage. In this way, the abutment element may also be centered by the groove of the filter housing in its radial position whereby the interaction of the two seals with the abutment element may be ensured in a beneficial manner.

According to a further aspect of the invention, a filter element for filtering a fluid, for example air, for a filter system is proposed, including a filter body with a filter medium arranged, when in use as intended, to be flowed through by the fluid in a flow direction for flow passage. In this context, the filter body includes at an end face a seal surrounding an outer edge which, when mounted as intended in a filter housing of the filter system, seal-tightly contacts a seal surface of a circumferential abutment element.

The proposed filter element may be configured, for example, as a flat filter element with foamed-on seal but other filter element shapes are also possible.

At the seal surface, the seal is compressed by the filter housing or a housing part of the filter housing. In this way, the seal-tightness between the filter element and the abutment element is ensured.

According to an embodiment of the filter element, the seal may include at an axial end a circumferential receptacle for at least partially receiving a collar of a housing part of the filter housing. In this way, the filter element, in relation to the filter housing or a housing part, may be expediently positioned such that the filter element is aligned for the installation in the filter housing. By the housing part which engages the receptacle of the seal, the seal may be compressed in axial direction, when the filter housing is closed as intended, so that the sealing action of the filter element in relation to the seal surface of the abutment element is ensured. In case of a radial sealing action, a housing part may engage the receptacle and support the seal radially inwardly.

According to an embodiment of the filter element, the receptacle in the seal may be arranged substantially at the same radial position as a region of the seal which is provided for contacting a seal surface in the filter housing when mounted as intended. In this manner, a beneficial compression of the seal of the filter element at a seal surface of the filter housing, for example the seal surface of the abutment part, may be realized.

According to an embodiment, the filter element may be embodied as a particle filter and/or as an adsorption filter, for example as an active carbon filter and/or as an ion exchanger. For example, in fuel cell systems particles as well as harmful gases may be filtered out of the intake air in this way.

### BRIEF DESCRIPTION OF THE DRAWINGS

Further advantages result from the following detailed description and the accompanying drawings. In the drawings, embodiments of the invention are illustrated. The drawings and the descriptions contain numerous features in combination. A person of skill in the art will consider the features expediently also individually and combine them to expedient further combinations.

FIG. 1 shows an isometric view of a filter system according to an embodiment of the invention.

FIG. 2 shows an isometric exploded illustration of the filter system according to FIG. 1.

FIG. 3 shows an exploded illustration of the filter system according to FIG. 1 in a side view.

FIG. 4 shows a plan view of the filter system according to FIG. 1 with marked section plane V-V.

FIG. 5 shows a section view of the section plane V-V according to FIG. 4 with marked detail VI.

FIG. 6 shows an enlarged illustration of the detail VI of the filter system according to FIG. 5.

### DETAILED DESCRIPTION

In the drawing figures, same or same-type components are identified with like reference characters. The drawing figures show only examples and are not to be understood as limiting.

Directional terminology used in the following with terms such as “left”, “right”, “top”, “bottom”, “in front of”, “behind”, “thereafter” and the like serve only for a better understanding of the drawing figures and is not at all meant to represent a limitation of the generality. The illustrated components and elements, their interpretation and use may vary in the context of considerations of a person of skill in the art and be adapted to the respective applications.

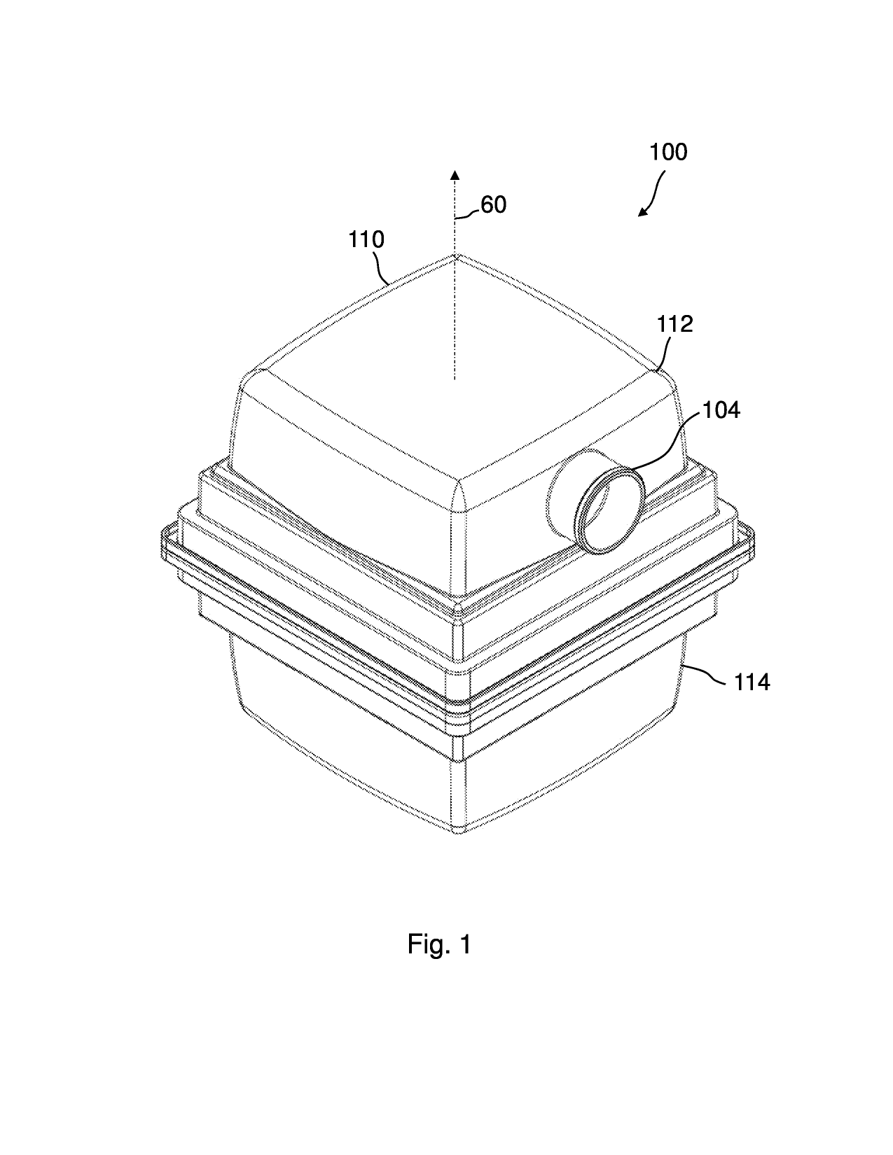

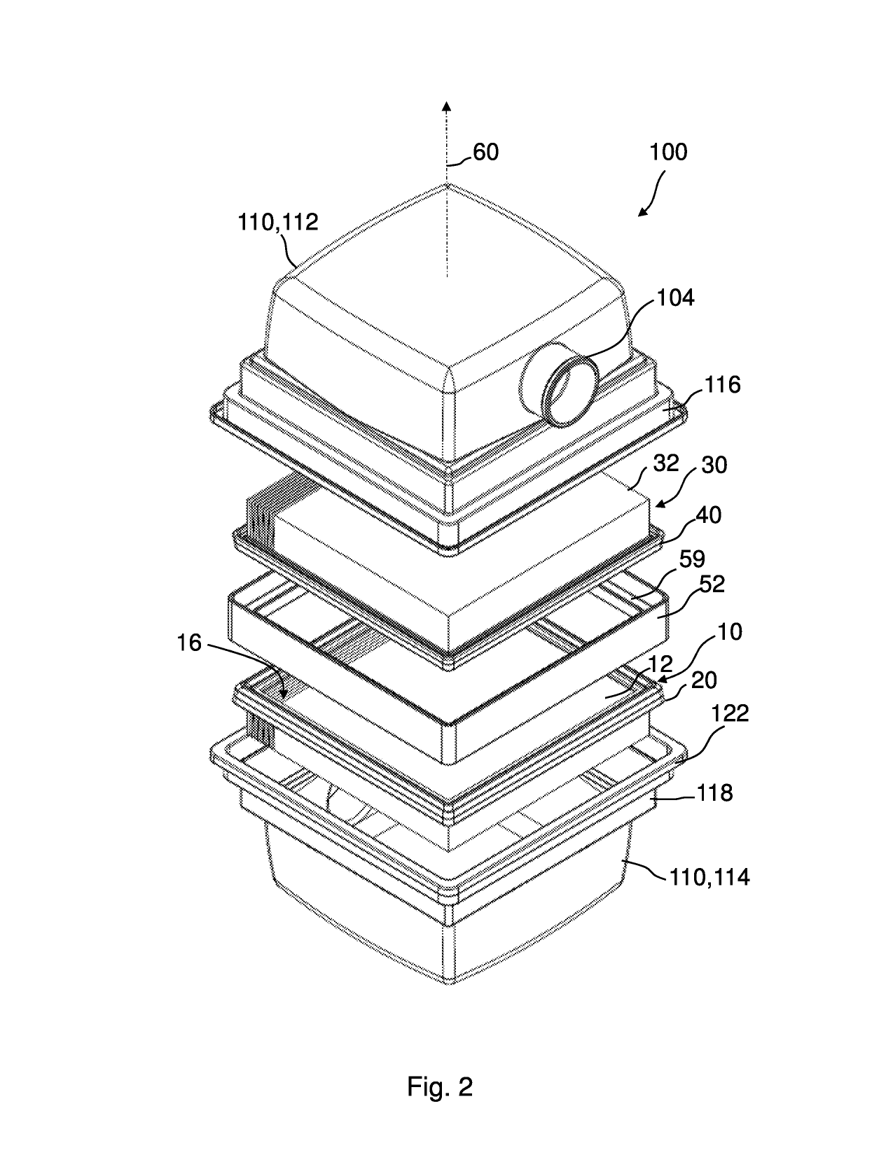

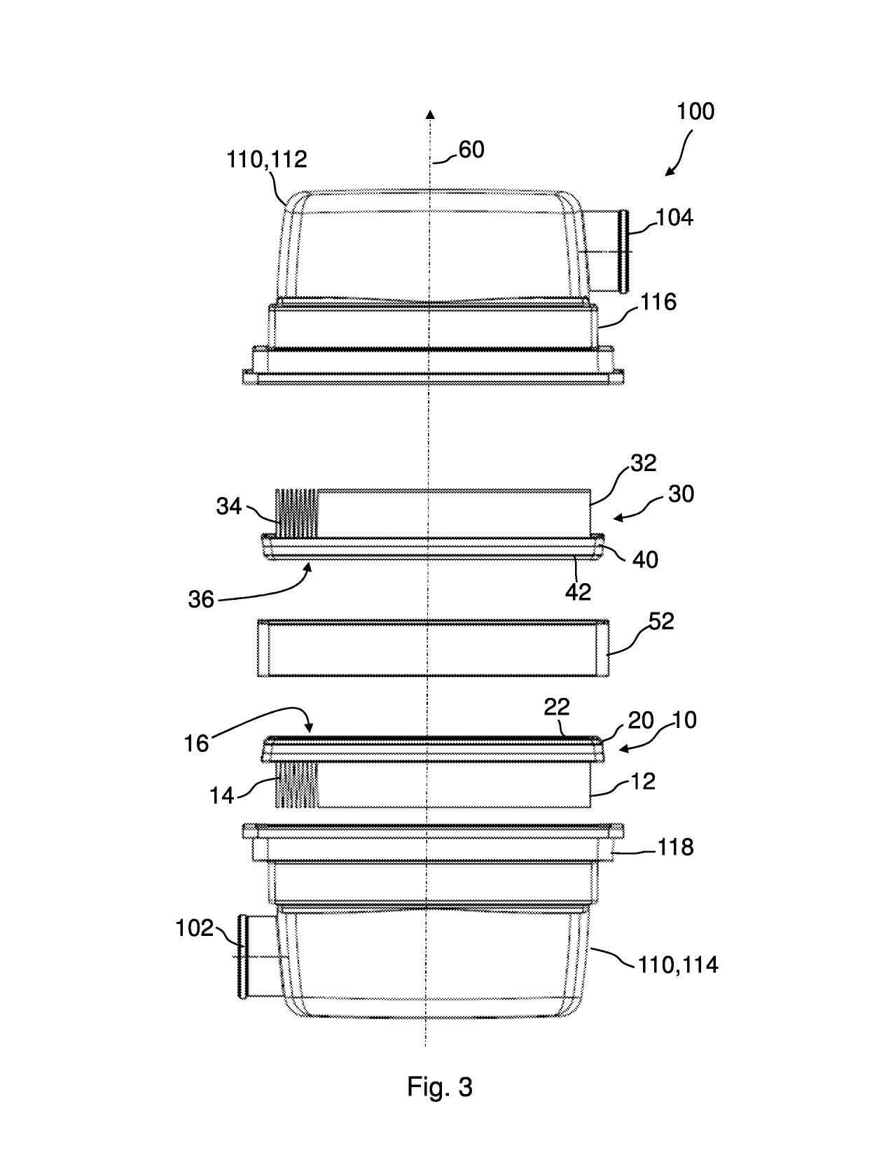

FIG. 1 shows an isometric view of a filter system 100 according to an embodiment of the invention. In FIG. 2, an isometric exploded illustration of the filter system 100 is illustrated, while FIG. 3 shows an exploded illustration of the filter system 100 in side view.

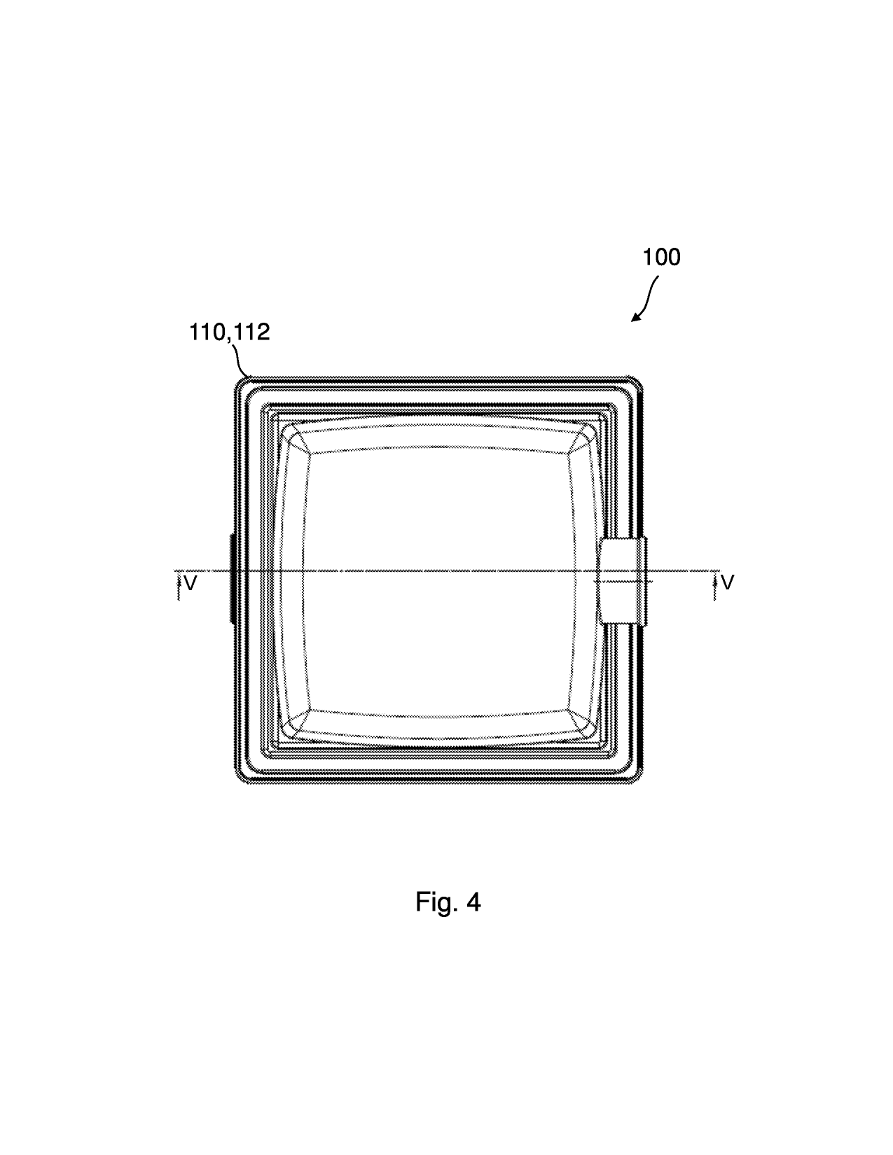

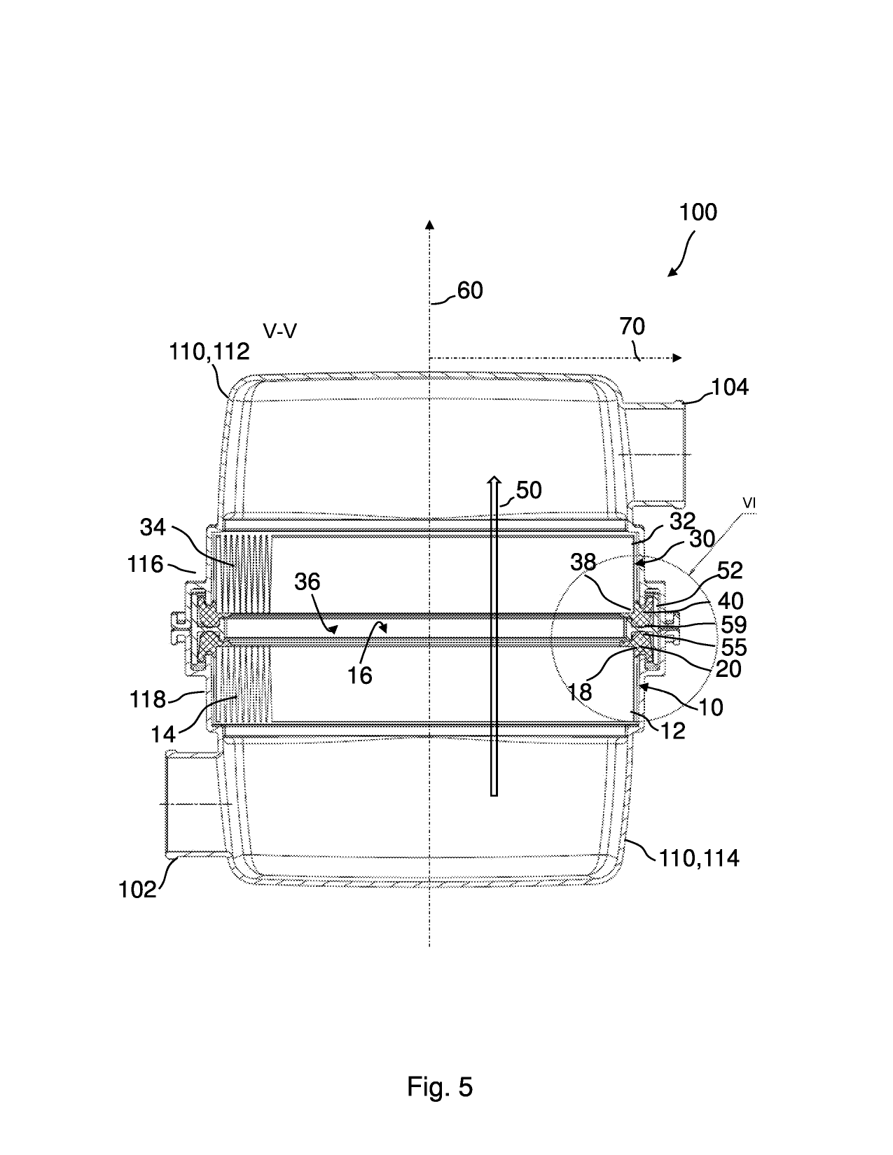

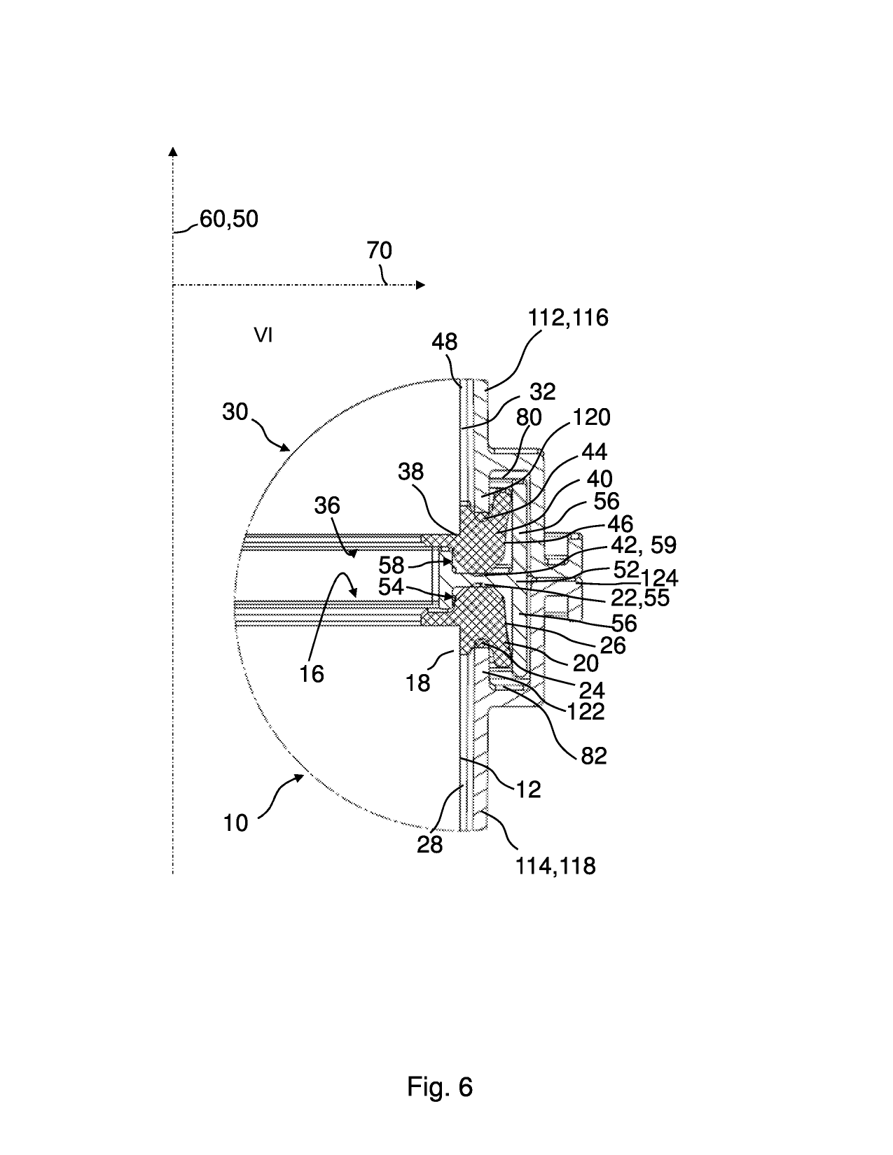

FIG. 4 shows a plan view of the filter system 100 with marked section plane V-V, wherein FIG. 5 shows the section view of the section plane V-V according to FIG. 4 with marked detail VI, and FIG. 6 shows an enlarged illustration of the detail VI of the filter system according to FIG. 5.

The filter system 100 comprises a filter housing 110 with a housing top part 112 and a housing bottom part 114, wherein a fluid inlet 102 (see FIG. 3; FIG. 5) is arranged at the housing bottom part 114 and a fluid outlet 104 at the housing top part 112. The filter housing 110 is flowed through by the fluid to be filtered from the housing bottom part 114 to the housing top part 112 in a flow direction 50 (see FIG. 5). The flow direction 50 corresponds to the axial direction 60 of the filter system 100.

As may be seen for example in FIGS. 2, 3, and 5, the filter system 100 comprises two exchangeable filter elements 10, 30 for filtering a fluid, for example for filtering air, which are arranged between the fluid inlet 102 and the fluid outlet 104. The filter elements 10, 30 each comprise a filter body 12, 32 with a filter medium 14, 34 arranged to be flowed through by the fluid in the flow direction 50 for flow passage, when in use as intended.

The filter medium 14, 34 may be configured, for example, as a nonwoven or filter paper and arranged folded, for example folded in a zigzag shape, in the filter body 12, 32. In the drawing figures, folds of the filter medium are illustrated only partially in the filter body 12, 32. Of course, the entire filter body 12, 32 is embodied with the folded filter medium 14, 34. The folds extend in this context between an inflow side and an outflow side, respectively. The filter medium 14, 34 may be sealed at its end face edges by a lateral strip 28, 48, as best seen in section in FIG. 6.

As may be seen for example in FIGS. 5 and 6, the filter elements 10, 30 comprise seals 20, 40 with seal surfaces 22, 42 at end faces 16, 36 facing each other, respectively, which seals circumferentially extend around outer edges 18, 38 of the filter elements 10, 30, respectively.

When the filter elements 10, 30 are mounted as intended in the filter housing 110, a circumferential abutment element 52 is arranged between the seals 20, 40 and comprises seal surfaces 55, 59 at sides facing away from each other for seal-tight contact of the seals 20, 40.

In the illustrated embodiment, the abutment element 52 is configured as a loose insertion part of the filter housing 110. The shape of the frame-type abutment element 52 is matched to the shape of the seals 20, 40. The cross section of the abutment element 52 is substantially T-shaped.

The abutment element 52 comprises two grooves 54, 58 for at least partially receiving the seals 20, 40. The seal surfaces 22, 42 of the seals 20, 40 are positioned respectively at the seal surfaces 55, 59 of the abutment element 52 which are formed by the respective groove 54, 58 bottom.

Expediently, the seals 20, 40 may be foamed onto the respective filter body 12, 32. Beneficially, in this context polyurethane (PUR) may be used as a material, for example.

The seal 20, 40 engages with a first holding section across an end face rim region and with a second holding section a lateral rim region of the filter body 12, 32 and is thus securely connected. The seal surfaces 22, 42 are arranged radially outside of the filter body 12, 32.

The respective seal 20, 40 comprises a circumferential receptacle 24, 44 positioned opposite the seal surface 22, 42 and engaged by a part of a housing part 112, 114 when the filter housing 110 is closed. One housing part 112 is a housing top part, for example, and the other housing part 114 a housing bottom part, for example. For this purpose, the housing parts 112, 114 each may comprise a collar 120, 122 as an extension of the housing wall 116, 118 which then engages the receptacle 24, 44 or, when the filter housing 110 is closed as intended, is pressed into the receptacle 24, 44. In this manner, the seals 20, 40, when the filter housing 110 is closed as intended, are compressed against the respective seal surface 55, 59 of the abutment element 52 in the axial direction 60 and opposite the axial direction, respectively.

In an embodiment, not illustrated, the seals 20, 40 may also be compressed optionally in a radial direction 70, when the filter housing 110 is closed as intended, against a radially outwardly positioned wall 56 of the abutment element 52, whereby the sealing action of the filter elements 10, 30 relative to each other may be further improved.

The filter element 10 which is flowed through first in the flow direction 50 may be designed as a particle filter while the filter element 30 following in the flow direction 50 may be designed as an adsorption filter, for example as an active carbon filter and/or as an ion exchanger. In this way, particles as well as harmful gases may be filtered out of the intake air in a fuel cell system, for example.

As best seen for example in FIG. 6, the filter housing 110 surrounds the seals 20, 40 at the radially outer side 26, 46. Housing top part 112 and housing bottom part 114 each comprise in this context a groove 80, 82 in which at least one wall 56 of the abutment element 52 engages. In this way, the seals 20, 40 may be protected from mechanical damage. In addition, in this way the abutment element 52 may be centered by the grooves 80, 82 of the filter housing 110 at its radial position in the radial direction 70, whereby the interaction of the two seals 20, 40 with the abutment element 52 may be ensured in a beneficial manner.

The free ends of the inner walls of the grooves 54, 58 of the abutment element 52 are supported at the end face holding sections of the end faces 16, 36 of the seals 20, 40, respectively.

In addition, an interface 124 for connecting the housing parts 112, 114 may be arranged at the surrounding portion of the seals 20, 40 so that in this manner a removal of a filter element 10, 30 from the housing part 112, 114 is facilitated during servicing.

In the detail VI of FIG. 6, the lateral strips 28, 48 which are glued to the end face edges of the filter medium 14, 34 may be seen.

### Reference Characters

10 filter element

12 filter body

14 filter medium

16 end face

18 outer edge

20 seal

22 seal surface

24 receptacle

26 outer side

28 lateral strip

30 filter element

32 filter body

34 filter medium

36 end face

38 outer edge

40 seal

42 seal surface

44 receptacle

46 outer side

48 lateral strip

50 flow direction

52 abutment element

54 groove of abutment element

55 seal surface of abutment element

56 wall

58 groove of abutment element

59 seal surface of abutment element

60 axial direction

70 radial direction

80 groove

82 groove

100 filter system

102 fluid inlet

104 fluid outlet

110 filter housing

112 housing part

114 housing part

116 housing wall

118 housing wall

120 collar

122 collar

124 housing interface

That which is claimed is:

1. A filter system comprising:
a filter housing comprising a fluid inlet and a fluid outlet:
at least two exchangeable filter elements arranged between the fluid inlet and the fluid outlet;
wherein the at least two exchangeable filter elements each comprise a filter body with a filter medium, wherein the filter medium is arranged to be flowed through by a fluid in a flow direction of the fluid;
wherein the at least two exchangeable filter elements each comprise an end face and a seal surrounding an outer edge of the filter body at the end face, wherein the end faces are arranged facing each other;
a circumferential abutment element arranged between the seals of the at least two exchangeable filter elements, wherein the circumferential abutment element comprises sides facing away from each other that each have a seal surface configured to seal-tightly contact a respective one of the seals of the at least two exchangeable filter elements.

2. The filter system according to claim 1, wherein the circumferential abutment element comprises at least one groove configured to receive at least partially at least one of the seals of the at least two exchangeable filter elements.

3. The filter system according to claim 1, wherein at least one of the seals of the at least two exchangeable filter elements is foamed onto the respective filter body.

4. The filter system according to claim 1, wherein the seals of the at least two exchangeable filter elements are compressed against the respective seal surfaces of the circumferential abutment element in an axial direction.

5. The filter system according to claim 1, wherein the seals of the at least two exchangeable filter elements each comprise a circumferential receptacle positioned opposite the respective seal surface of the circumferential abutment element and engaged by a housing part of the filter housing.

6. The filter system according to claim 1, wherein the seals of the at least two exchangeable filter elements are compressed in a radial direction against a radially outer wall of the circumferential abutment element.

7. The filter system according to claim 1, wherein the at least two exchangeable filter elements include a first filter element flowed through first in the flow direction and a second filter element flowed through second in the flow direction, wherein the first filter element is a particle filter and/or wherein the second filter element is an adsorption filter.

8. The filter system according to claim 7, wherein the adsorption filter is an active carbon filter and/or an ion exchanger.

9. The filter system according to claim 1, wherein the filter housing surrounds the circumferential abutment element at a radially outer side of the circumferential abutment element.

10. The filter system according to claim 9, wherein the filter housing comprises at least one groove engaged by at least one wall of the circumferential abutment element.

11. The filter system according to claim 1, wherein the filter system is an air filter in a fuel cell system.

12. The filter system according to claim 1, wherein the at least two exchangeable filter elements include a first filter element flowed through first in the flow direction and a second filter element flowed through second in the flow direction, and wherein the first filter element is a particle filter and the second filter element is an adsorption filter.

13. A filter element for filtering a fluid, the filter element comprising:
a filter body with a filter medium arranged to be flowed through by the fluid in a flow direction of the fluid;
wherein the filter body comprises an end face and a seal surrounding an outer edge of the filter body at the end face;
wherein the seal seal-tightly contacts a seal surface of a circumferential abutment element.

14. The filter element according to claim 13, wherein the seal comprises at an axial end a circumferential receptacle configured to receive at least partially a collar of a housing part of a filter housing.

15. The filter element according to claim 14, wherein the circumferential receptacle of the seal is arranged at a same radial position as a region of the seal which is configured to contact the seal surface of the circumferential abutment element.
